(19) United States
(12) Patent Application Publication
(10) Pub. No.: US 2015/0371069 A1
(43) Pub. Date: Dec. 24, 2015

(54) SYSTEM AND METHOD FOR MONITORING MEDICAL ASSET BY GENERATING FINGERPRINT ASSOCIATED WITH VIBRATION PATTERN

(71) Applicant: Will Rosellini, Dallas, TX (US)

(72) Inventor: Will Rosellini, Dallas, TX (US)

(73) Assignee: REMOTE BIOMEDICAL LLC, Dallas, TX (US)

(21) Appl. No.: 14/309,974

(22) Filed: Jun. 20, 2014

(51) Int. Cl. G06K 7/10; H04W 4/02

(52) U.S. Cl. CPC G06K 7/10366; H04W 4/02

(57) ABSTRACT

Disclosed is a method for executing one or more algorithms for monitoring one or more medical assets within a Bluetooth low energy enabled wireless network, wherein the method comprises of identifying and classifying one or more medical assets to be monitored. Further, the method generates fingerprint based on the vibration pattern using a vibration sensor determined for one or more medical assets. Further, the method associates the generated fingerprint with wireless Radio Frequency Identification (RFID) tags and Real Time Locating System (RTLS) tags and executes the algorithm for monitoring one or more medical assets using the RFID and RTLS tags.

### BACKGROUND

### Field Of The Invention

The present invention relates to monitoring medical assets and more particularly relates to executing one or more algorithms for monitoring one or more medical assets within a Bluetooth low energy (Bluetooth-LE) enabled wireless network.

In the current scenario, medical assets can be monitored using various techniques including the Radio Frequency Identification (RFID) and Real Time Locating System (RTLS) tags in a wireless network. As the number of the medical asset type increases, monitoring all type of assets accurately becomes a challenging task. Also, the medical assets can be part of various types of networks. Hence, there is a need for monitoring various types of medical assets more precisely and determining if the medical assets are utilized or not.

In light of what is discussed above, there is a need to provide a more advanced way of monitoring the medical assets available within the wireless network and determining the utilitarian aspect of the medical assets.

### SUMMARY

The present invention comprises a method for executing one or more algorithms for monitoring one or more medical assets within a Bluetooth low energy (Bluetooth-LE) enabled wireless network, wherein the method comprises of identifying one or more medical assets to be monitored. Further, the method comprises of classifying one or more medical assets under one or more pre-defined categories and determining the classification of medical assets based on the Radio Frequency Identification (RFID) and Real Time Locating System (RTLS) tags. Further, the method determines the vibration pattern of one or more classified medical assets using a vibration sensor. Further, the method generates fingerprint based on the determined vibration pattern and associates the generated fingerprint with the RFID and RTLS tags. Further, the method executes the identified algorithm for monitoring one or more medical assets using the RFID and RTLS tags.

Other objects and advantages of the embodiments herein will become readily apparent from the following detailed description taken in conjunction with the accompanying drawings.

### BRIEF DESCRIPTION OF THE DRAWINGS

FIGS. 1a and 1b, according to an embodiment of the present invention, is an illustration of a system overview for monitoring one or more medical assets within a Bluetooth low energy (Bluetooth-LE) enabled wireless network.

FIG. 2, according to an embodiment of the present invention, is an illustration of a medical asset monitoring system 100 that comprises of various modules.

FIG. 3, according to an embodiment of the present invention, is an illustration of a flow chart that describes the process of monitoring medical assets within the Bluetooth-LE enabled wireless network.

FIG. 4, according to an embodiment of the present invention, is an illustration of exemplary way of monitoring specimen used in consumables.

FIG. 5, according to an embodiment of the present invention, is an illustration of exemplary way of monitoring the usage of infusion pumps.

### FIGURES—REFERENCE NUMERALS

100—System for monitoring medical assets
101—Bluetooth Low Energy (Bluetooth-LE) Network/wireless network
102—Vibration sensors
103—Information engine
104—Client device

### DETAILED DESCRIPTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

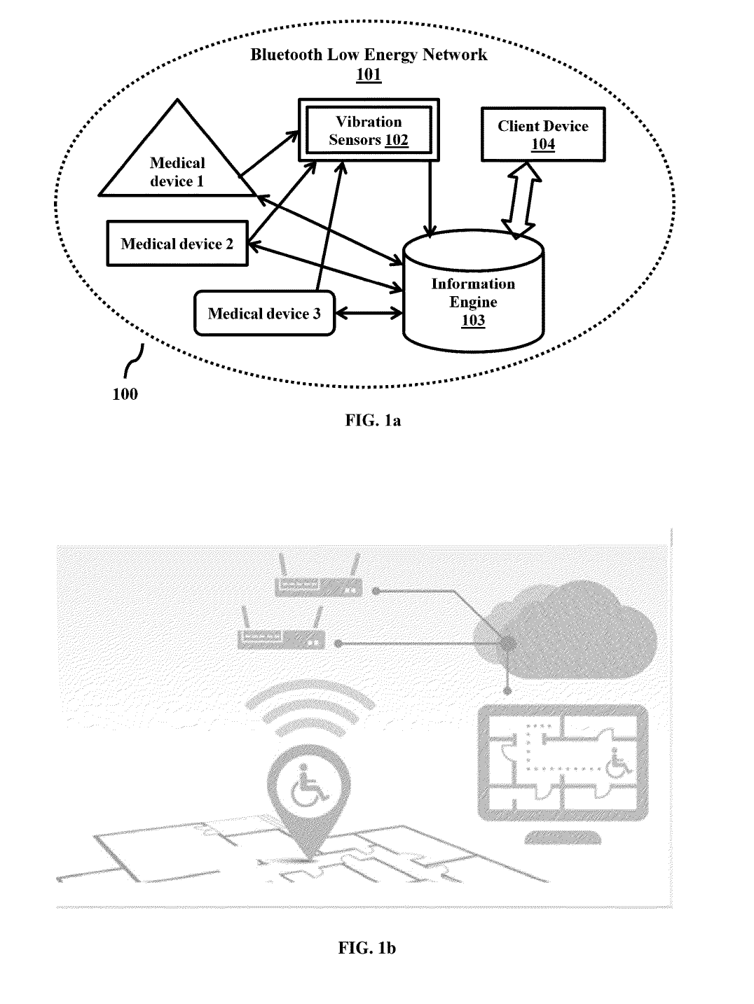

Referring to FIGS. 1a and 1b, the system 100 for monitoring medical assets comprises of one or more medical assets available within a Bluetooth Low Energy (Bluetooth-LE) wireless network 101, Vibration sensors 102 used to sense the vibration of the monitored medical asset, an Information engine 103 used to generate fingerprint from the vibration pattern recognized from the vibration sensors 102, a Client device 104 used to specify a query or identify the medical assets for monitoring.

In an embodiment, the wireless network 101 supported by the method for monitoring one or more medical devices includes but not limited to a Wireless Fidelity (Wi-Fi) network, a cellular network, or a WiMAX network.

In an embodiment, the Vibration sensors 102 configured to sense the vibration pattern of the medical assets can be either associated with individual medical asset or installed within the system 100 to identify the vibration pattern occurring within the network 101.

In an embodiment, the Information engine 103 is configured to generate the fingerprint based on the vibration pattern identified for one or more medical assets. Further, the generated fingerprint is associated with the Radio Frequency Identification (RFID) and the Real Time Locating System (RTLS) tags. The method monitors the medical asset based on the RFID and RTLS tags associated with the medical asset. As depicted in figure lb, the vibration pattern of the wheel chair being used is identified within the wireless network 101 and is displayed on the client device 104.

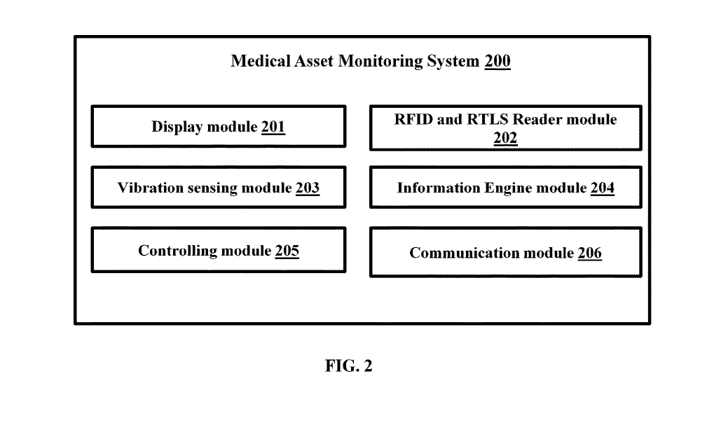

Referring to FIG. 2, the medical asset monitoring system 100 comprises of the following modules: a Display module 201, an RFID and RTLS reader module 202, a Vibration sensing module 203, an Information engine module 204, a Controlling module 205, and a Communication module 206. In an embodiment, the Display module 201 is configured to display the monitored values on the Client device 104 and to allow the users to specify/select the medical assets to be monitored. The RFID and RTLS readers are used to read the RFID and RTLS tags associated with the monitored medical assets. In an embodiment, the Vibration sensing module 203 is configured to identify the vibration pattern associated with the monitored medical asset within the wireless network 101. Vibration pattern is determined using the vibration sensors 102 that can be either attached to individual medical assets or remotely placed within the wireless network 101. In an embodiment, the Information engine module 204 is configured to generate fingerprint based on the vibration pattern determined for the monitored medical asset. The Controlling module 205 can be configured to perform various activities associated with the medical asset monitoring system 100. For example, the Controlling module 205 can be configured to associate the generated fingerprint of the monitored medical asset with the RFID and RTLS tags. The Communication module 206 is configured to allow various modules within the wireless network 101 to communicate.

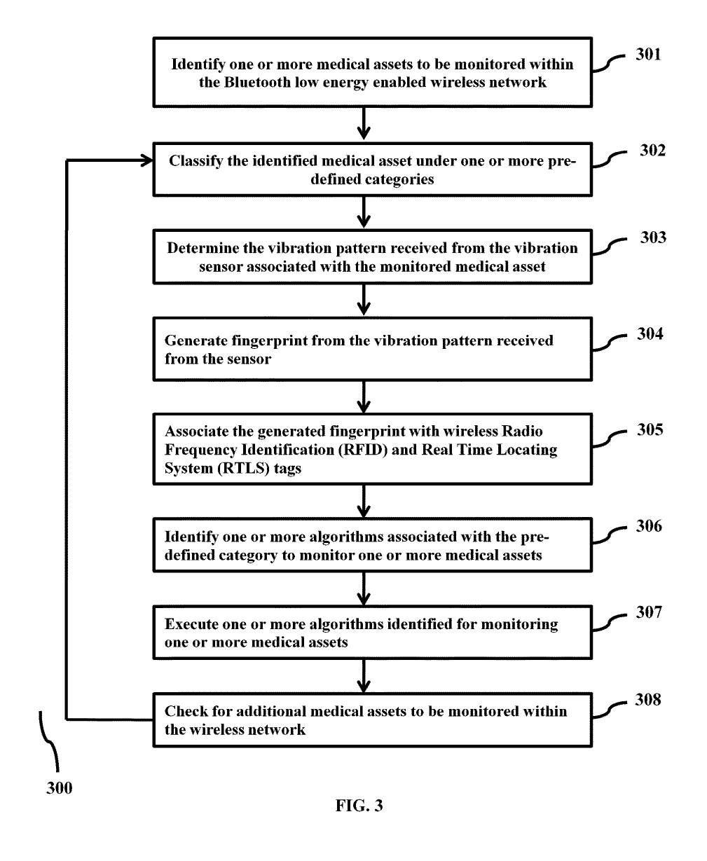

Referring to FIG. 3, the method 300 explains the process of monitoring medical assets within the wireless network 101 based on the vibration pattern determined for the monitored medical assets. Initially, at step 301 the user can select one or more medical assets to be monitored within the wireless network 101. In an embodiment, the Display module 201 can be used to select or specify one or more medical assets to be monitored within the wireless network 101. For example, the medical assets to be monitored includes but not limited to Infusion pumps, Ventilators, Laptops, Autoclaves, Power generators, Medical specimens or the like. At step 302, the selected medical asset can be categorized under one or more pre-defined categories based on the RFID and RTLS tags associated with the medical asset. In an embodiment, the Controlling module 205 can be configured to categorize the selected medical assets under one or more pre-defined categories by reading the RFID and RTLS tags. For example, if the pre-defined categories comprises of Medical equipment, Facility equipment, IT assets, Laboratory equipment, Manufacturing assets, Consumables-Supplies-Specimens then the following assets can be included under each of these categories respectively: Infusion pumps, Power generators, Smart phones, Autoclaves, Specialized equipment, Medication. At step 303, the method 300 starts monitoring the selected medical asset by determining the vibration pattern received from the medical asset. In an embodiment, the Vibration sensing module 203 is configured to sense the vibration pattern of the monitored medical asset. For example, when the infusion pumps are used or handled by the users the Vibration sensing module 203 senses the vibration pattern using the vibration sensors 102. At step 304, the method 300 generates fingerprint based on the vibration pattern received from the monitored medical asset. In an embodiment, the Information engine 103 is configured to generate fingerprint based on the vibration pattern received from the monitored medical asset. For example, when the infusion pumps are used, the fingerprint of the user using the infusion pump is generated based on the usage of the infusion pump. At step 305, the method 300 associates the generated fingerprint with the RFID and RTLS tags of the monitored medical asset. In an embodiment, the Controlling module 205 is configured to associate the generated fingerprint with the RFID and RTLS tags of the monitored medical asset.

At step 306, the method 300 identifies one or more algorithms for monitoring the medical asset based on the categorization of the medical asset. In an embodiment, the Controlling module 205 is configured to identify one or more algorithms for monitoring the medical asset based on the categorization of the medical asset. For example, if the laboratory equipment medical asset category is selected for monitoring, then algorithms that can monitor the laboratory equipment medical assets are identified. In an embodiment, monitoring the medical assets comprises of determining the usage factor of the medical asset, determining the location, determining the position, determining the availability of the medical asset within the wireless network 101 or the like. At step 307, the method 300 executes one or more algorithms identified based on the pre-defined categories associated with the monitored medical assets. In an embodiment, the Controlling module 205 is configured to execute one or more algorithms that are identified based on the pre-defined categories associated with the monitoring medical assets. At step 308, the method 300 determines if additional medical assets are to be monitored within the network 101. In an embodiment, the Controlling module 205 is configured to determine if additional medical assets are to be monitored within the network 101.

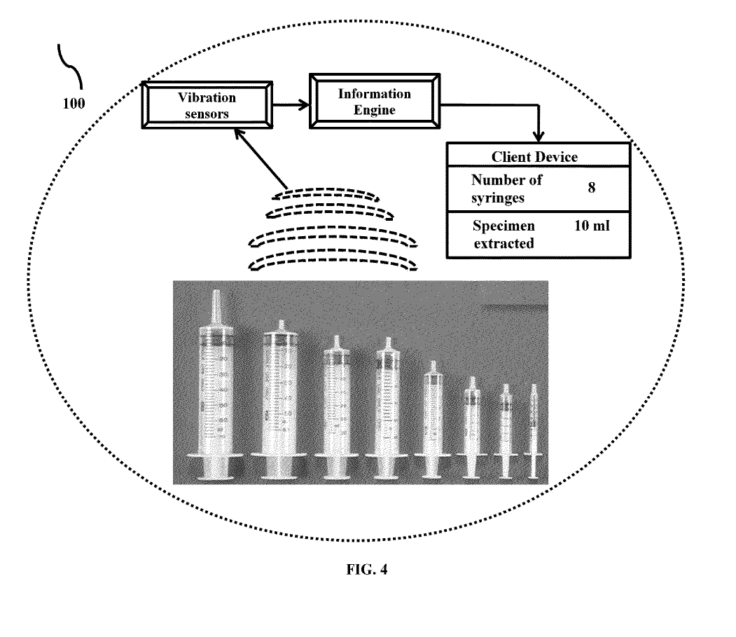

Referring to FIG. 4, the medical asset monitoring system 100 is used to monitor the number of syringes available within the wireless network 101 and the quantity of specimen extracted from the syringes. As depicted in the figure, the client device queries for checking the number of syringes available within the wireless network 101. Based on this query, the monitoring system 100 determines the type of asset (syringes) to be consumables and identifies an algorithm to monitor the syringes. The identified algorithm starts monitoring the syringes after determining the vibration pattern of the syringes and generating the fingerprint based on the vibration pattern.

The medical asset monitoring system 100 associate the generated fingerprint with the RFID and RTLS tags based on which the algorithm monitors the syringes. Further, the algorithm determines the number of syringes available within the network 101 as 8 and the quantity of specimen extracted from the syringes as 10 ml. Further, the medical asset monitoring system 100 displays the monitored information on the client device.

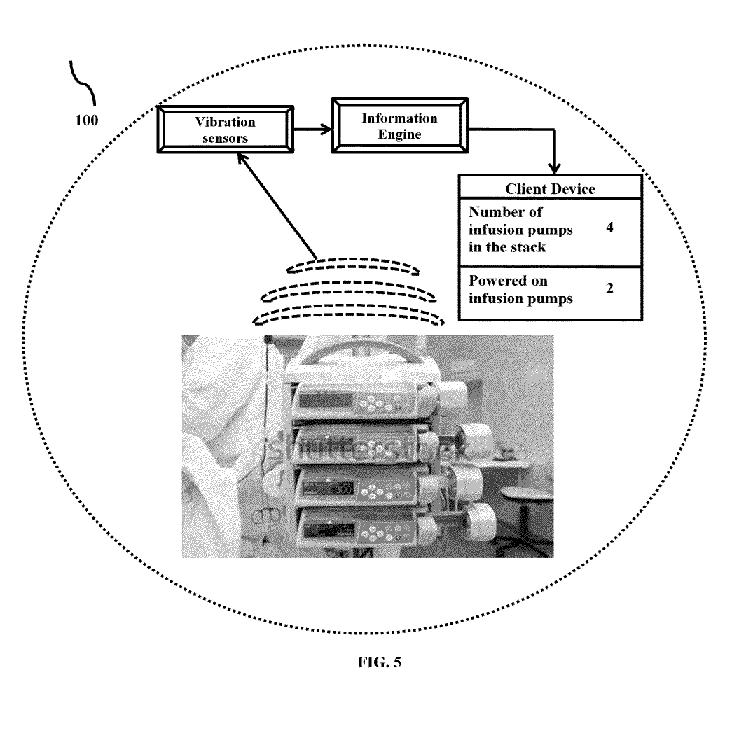

Referring to FIG. 5, the medical asset monitoring system 100 is used to monitor the number of infusion pumps available within the wireless network 101 and the number of infusion pumps currently in use. As depicted in the figure, the client device queries for checking the number of infusion pumps available within the wireless network 101. Based on this query, the monitoring system 100 determines the type of asset (infusion pumps) to be medical equipment and identifies an algorithm to monitor the infusion pumps. The identified algorithm starts monitoring the medical equipment asset after determining the vibration pattern of the infusion pumps handled by the user and generating the fingerprint based on the vibration pattern. The medical asset monitoring system 100 associate the generated fingerprint with the RFID and RTLS tags based on which the algorithm monitors the selected medical asset. Further, the algorithm determines the number of infusion pumps available within the network 101 as 4 and the number of infusion pumps that are currently in use as 2. Further, the medical asset monitoring system 100 displays the monitored information on the client device.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

What is claimed is:

1. A method for executing at least one algorithm for monitoring at least one medical asset within a Bluetooth low energy enabled wireless network, wherein said method comprises of:
identifying said at least one medical asset to be monitored by using a wireless Radio Frequency Identification (RFID) and Real Time Locating System (RTLS) tag readers;
classifying said at least one medical asset under at least one pre-defined category by using said RFID and RTLS tag;
determining the vibration pattern of said at least one medical asset that is classified using a vibration sensor;
generating fingerprint based on said determined vibration pattern;
associating said generated fingerprint with said RFID and RTLS tags;
identifying said at least one algorithm associated with said at least one pre-defined category; and
executing said at least one algorithm that is identified for monitoring said at least one medical asset.

2. The method as claimed in claim 1, wherein said at least one medical asset that is being monitored is classified based on a fingerprint generated from a vibration pattern received from a vibration sensor associated with said at least one medical asset.

3. The method as claimed in claim 2, wherein said fingerprint generated from said vibration pattern received from said vibration sensor is associated with said RFID and RTLS tags.

4. The method as claimed in claim 3, wherein identifying said at least one algorithm for monitoring said at least one medical asset can be achieved by using said RFID and RLTS tags.

5. The method as claimed in claim 4, wherein said at least one algorithm identified for monitoring said at least one medical asset must be capable of determining the usage factor of the monitored said at least one medical asset.

6. The method as claimed in claim 5, wherein said usage factor of the monitored said at least one medical asset varies across pre-defined categories available for classifying said at least one medical asset, wherein said usage factor includes but not limited to amount of medical specimens available in consumables, number of power generators used, number of nebulizers used, duration for which the testing equipment is used or the like.

7. The method as claimed in claim 1, wherein monitoring said at least one medical asset further comprises of determining the location, determining the position, determining the availability of said at least one medical asset identified within said wireless network or the like.

8. The method as claimed in claim 1, wherein the method can be used to monitor said at least one medical asset available within any other type of wireless network such as a Wireless Fidelity (Wi-Fi) network, a cellular network, or a WiMAX network.

9. A System for monitoring at least one medical asset within a Bluetooth low energy wireless network, wherein the system comprises of a Radio Frequency Identification (RFID) and a Real Time Locating System (RTLS) tag readers, a vibration sensor, and an information engine, wherein said system is configured to:
identify said at least one medical asset to be monitored within said wireless network by using said RFID and RTLS tag readers;
classify said at least one medical asset under at least one pre-defined category by using said RFID and RTLS tag;
determine vibration pattern of said at least one medical asset that is classified by using a vibration sensor;
generate fingerprint based on said determined vibration pattern by using an information engine;
associate said generated fingerprint with RFID and RTLS tags; and
monitor said at least one medical asset using said wireless RFID and RTLS tags.

10. The system as claimed in claim 9, wherein said system can be configured to classify said at least one medical asset that is being monitored based on a fingerprint generated from a vibration pattern received from a vibration sensor associated with said at least one medical asset.

11. The system as claimed in claim 10, wherein said system is further configured to associate said fingerprint generated from said vibration pattern received from said vibration sensor with said RFID and RTLS tags.

12. The system as claimed in claim 11, wherein said system is further configured to identify said at least one algorithm for monitoring said at least one medical asset by using said RFID and RLTS tags.

13. The system as claimed in claim 12, wherein said system is further configured to determine the usage factor of the monitored said at least one medical asset by using said at least one algorithm identified for monitoring said at least one medical asset.

14. The system as claimed in claim 13, wherein said usage factor of the monitored said at least one medical asset varies across pre-defined categories available for classifying said at least one medical asset.

15. The system as claimed in claim 1, wherein said system is configured to monitor said at least one medical asset by determining the location, determining the position, determining the availability of said at least one medical asset identified within said wireless network or the like.

16. The system as claimed in claim 1, wherein said system is configured to monitor said at least one medical asset available within any other type of wireless network such as a Wireless Fidelity (Wi-Fi) network, a cellular network, or a WiMAX network.
